(19) United States
(12) Patent Application Publication
(10) Pub. No.: US 2021/0298154 A1
(43) Pub. Date: Sep. 23, 2021

(54) Human-Presence-Responding Luminance System

(71) Applicant: XIAMEN ECO LIGHTING CO. LTD., Xiamen (CN)

(72) Inventors: Jianxin XIE, Xiamen (CN); Wenhui YANG, Xiamen (CN); Tian LAN, Xiamen (CN); Liping LIN, Xiamen (CN)

(21) Appl. No.: 16/821,854

(22) Filed: Mar. 17, 2020

(51) Int. Cl. H05B 47/115; G08C 17/00

(52) U.S. Cl. CPC H05B 47/115; G08C 2201/40; G08C 17/00

(57) ABSTRACT

A human-presence-responding luminance system includes an illuminating device and a luminance adjusting device. The luminance adjusting module includes a human proximity sensor, a luminance determining module and a transmission module. The human proximity sensor detects a current location of a human appearing in its proximity. The luminance determining module determines whether the current location of the human is within a first predetermined region and whether the current location of the human is within a second predetermined region. The first predetermined region substantially covers the second predetermined region. In addition, the luminance determining module sets a luminance controlling signal to a higher average luminance when the current location of the human is within the second predetermined region. Otherwise, the luminance determining module sets the luminance controlling signal to a lower average luminance when the current location is within the first predetermined region but is not within the second predetermined region.

### FIELD OF THE INVENTION

The present invention relates to a human-presence-responding luminance system, and more particularly, to a luminance system capable of adjusting its luminance in response to appearance or disappearance of at least one human.

### BACKGROUND OF THE INVENTION

As smart illuminating technology develops, illuminance based on safety, low power consumption, comfort, and high efficiency is highly required. For meeting such requirements, conventional human proximity sensors are arranged into an array, i.e., a conventional array-formed human proximity sensor, to determine an exact location of a nearby human. Such that conventional illuminating devices can be activated in response to the human's current location.

Such conventional array-formed human proximity sensors ordinarily include two types: low-resolution array-formed human proximity sensors and high-resolution array-formed human proximity sensors. The low-resolution array-formed human proximity sensors are easy to control because of a smaller detection range. However, the low-resolution array-formed human proximity sensors cannot meet most of the abovementioned requirements. On the contrary, the high-resolution array-formed human proximity sensors have a large detection range and meet more requirements. However, the high-resolution array-formed human proximity sensors are far from being cost-effective.

### SUMMARY OF THE INVENTION

The present disclosure aims at disclosing a human-presence-responding luminance system. The human-presence-responding luminance system includes an illuminating device and a luminance adjusting device. The luminance adjusting device is electronically coupled to the illuminating device. The luminance adjusting module includes a human proximity sensor, a luminance determining module and a transmission module. The human proximity sensor detects a current location of a human appearing in its proximity. The luminance determining module determines whether the current location of the human is within a first predetermined region. Also, the luminance determining module determines whether the current location of the human is within a second predetermined region when the human is located within the first predetermined region. The first predetermined region substantially covers the second predetermined region. In addition, the luminance determining module sets a luminance controlling signal to a first average luminance when the current location of the human is within the second predetermined region. Otherwise, the luminance determining module sets the luminance controlling signal to a second average luminance when the current location is within the first predetermined region but is not within the second predetermined region. The transmission module relays the luminance controlling signal to the illuminating device. The first average luminance is higher than the second average luminance. The illuminating device illuminates according to an average luminance indicated by the luminance controlling signal.

In one example, factors of the average luminance include a magnitude of luminance, a color temperature radiated from the illuminating device, and/or a flashing frequency of the illuminating device.

In one example, the second predetermined region separates all connected subregions of the first predetermined region.

In one example, the first predetermined region and the second predetermined region are concentric circles having a same center.

In one example, when the luminance determining module determines that the current location of human falls outside the first predetermined region, the luminance determining module sets the luminance controlling signal to render the illuminating device to switch off immediately or gradually.

In one example, the luminance determining module determines a lasting time that the human stays within the first predetermined region. Also, the luminance determining module determines whether the lasting time exceeds a predetermined duration.

In one example, the luminance determining module sets the luminance controlling signal to render the illuminating device to switch off immediately or gradually when the lasting time fails to exceed the predetermined duration.

In one example, the luminance determining module determines whether the current location of the human is within a third predetermined region. The third predetermined region substantially covers the first predetermined region. In addition, the luminance determining module determines whether the human is moving within the third predetermined region upon determining that the human is within the third predetermined region. Moreover, the luminance determining module determines whether the human is moving towards the first predetermined region upon determining that the human is moving. Also, the luminance determining module sets the luminance controlling signal to render the illuminating device to switch on immediately or gradually when the human is moving towards the first predetermined region.

In one example, the first predetermined region separates all connected subregions of the third predetermined region.

In one example, the first predetermined region, the second predetermined region and the third predetermined regions are concentric circles having a same center.

In one example, the luminance determining module is integrated with the human proximity sensor.

In one example, the luminance determining module is integrated with the illuminating device.

The present disclosure additionally discloses another human-presence-responding luminance system. The human-presence-responding luminance system includes a plurality of illuminating devices and a plurality of luminance adjusting devices. The plurality of luminance adjusting devices have a one-by-one correspondence with the plurality of illuminating devices. The plurality of luminance adjusting devices are arranged in a matrix. Each of the plurality of luminance adjusting device includes a human proximity sensor, a luminance determining module and a transmission module. The human proximity sensor detects a current location of a human appearing in its proximity. The luminance determining module determines whether the current location of the human is within a first predetermined region. Also, the luminance determining module determines whether the current location of the human is within a second predetermined region when the human is located within the first predetermined region. The first predetermined region substantially covers the second predetermined region. Moreover, the luminance determining module sets a luminance controlling signal to a first average luminance when the current location of the human is within the second predetermined region. In addition, the luminance determining module sets the luminance controlling signal to a second average luminance when the current location is within the first predetermined region but is not within the second predetermined region. The transmission module relays the luminance controlling signal to a correspond illuminating device out of the plurality of illuminating devices. The first average luminance is higher than the second average luminance. The corresponding illuminating device illuminates according to an average luminance indicated by the luminance controlling signal. The human proximity sensors of all the plurality of luminance adjusting devices communicate with each other with the aid of the transmission module.

In one example, factors of the average luminance comprise a magnitude of luminance, a color temperature radiated from the illuminating device, and/or a flashing frequency of the illuminating device.

In one example, the second predetermined region separates all connected subregions of the first predetermined region.

In one example, the first predetermined region and the second predetermined region are concentric circles having a same center.

In one example, when the luminance determining module determines that the current location of human falls outside the first predetermined region, the luminance determining module sets the luminance controlling signal to render the corresponding illuminating device to switch off immediately or gradually.

In one example, the luminance determining module determines a lasting time that the human stays within the first predetermined region. Also, the luminance determining module determines whether the lasting time exceeds a predetermined duration.

In one example, the luminance determining module sets the luminance controlling signal to render the corresponding illuminating device to switch off immediately or gradually when the lasting time fails to exceed the predetermined duration.

In one example, the luminance determining module determines whether the current location of the human is within a third predetermined region that substantially covers the first predetermined region. Moreover, the luminance determining module determines whether the human is moving within the third predetermined region upon determining that the human is within the third predetermined region. In addition, the luminance determining module determines whether the human is moving towards the first predetermined region upon determining that the human is moving. Also, the luminance determining module sets the luminance controlling signal to render the corresponding illuminating device to switch on immediately or gradually.

In one example, the first predetermined region separates all connected subregions of the third predetermined region.

In one example, the first predetermined region, the second predetermined region and the third predetermined regions are concentric circles having a same center.

In one example, the luminance determining module is integrated with the human proximity sensor.

In one example, the luminance determining module is integrated with the corresponding illuminating device.

In one example, the human proximity sensor forwards the current location of the human to at least one the other luminance adjusting device with the aid of the transmission module.

In one example, the human proximity sensor selects the at least one the other luminance adjusting device according to proximities of the current location of the human to the other luminance adjusting devices.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a human-presence-responding luminance system according to one embodiment.

FIG. 2 illustrates a flowchart of how the human-presence-responding luminance system shown in FIG. 1 works to adjust its luminance according to one embodiment.

FIG. 3 and FIG. 4 illustrate two examples illustrating the correspondence between the first predetermined region and the second predetermined region indicated in FIG. 2.

FIG. 5 illustrates a flowchart of how human-presence-responding luminance system shown in FIG. 1 adjusts its illuminating device's luminance by additionally taking a lasting time of a detected human into considerations.

FIG. 6 illustrates how the luminance determining module shown in FIG. 1 prepares lighting up the detected human's way before he/she reaches the first predetermined region indicated in FIG. 2 according to one example.

FIG. 7 and FIG. 8 illustrate two examples illustrating the correspondence between the first predetermined region, the second predetermined region and the third predetermined region indicated in FIG. 2 and FIG. 6.

FIG. 9 illustrates an exemplary diagram of coupling multiple luminance adjusting devices shown in FIG. 1 in a mesh.

### DETAILED DESCRIPTION

As mentioned above, the present disclosure discloses a human-presence-responding luminance system for substantially neutralizing: (1) the lack of functionality caused by utilizing low-resolution array-formed human proximity sensors; and (2) the high cost caused by utilizing high-resolution array-formed human proximity sensors.

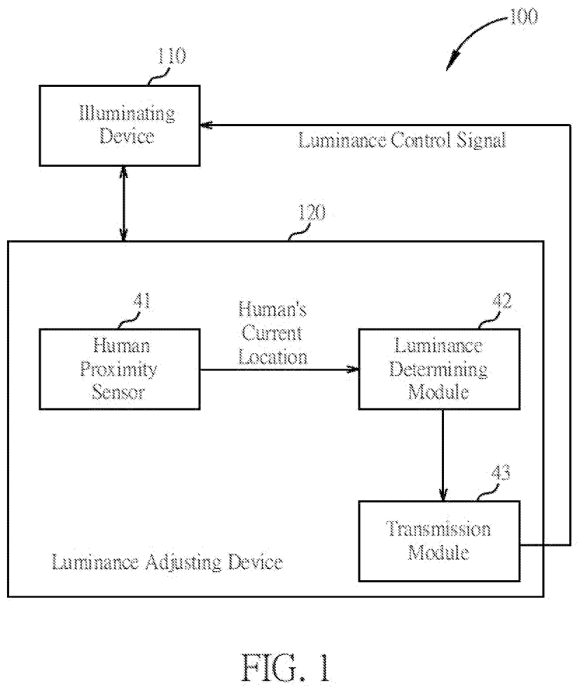

FIG. 1 illustrates a human-presence-responding luminance system 100 according to one embodiment. As shown in FIG. 1, the human-presence-responding luminance system 100 includes an illuminating device 110 and a luminance adjusting device 120. The illuminating device 110 illuminates for lighting up a target's surroundings for better vision. Ordinarily, such target indicates at least one human. The luminance adjusting device 120 adjusts the illuminating device 110's luminance according to the target's current location, for concentrating power consumption in a desired manner and avoiding unnecessary power consumption.

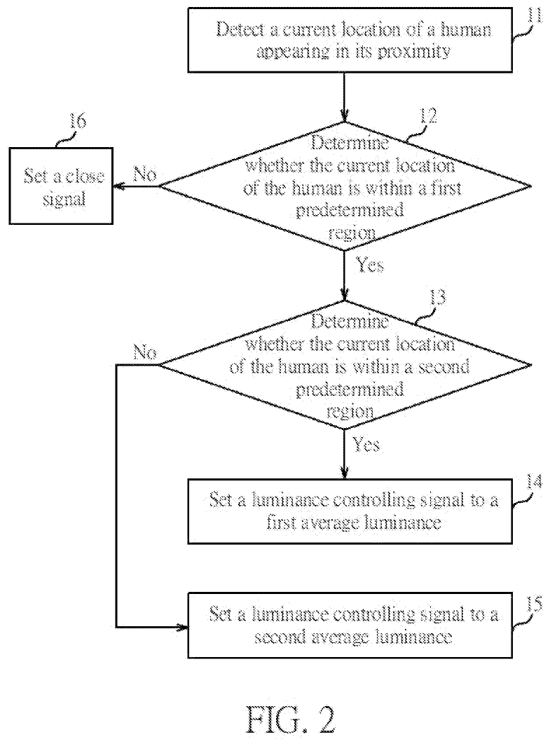

FIG. 2 illustrates a flowchart of how the human-presence-responding luminance system 100, specifically the luminance adjusting device 120, works to adjust its luminance according to one embodiment.

In one example, the luminance adjusting device 120 includes a human proximity sensor 41, a luminance determining module 42 and a transmission module 43.

In Step 11, the human proximity sensor 41 detects a current location of a human appearing in its proximity.

In Step 12, the luminance determining module 42 determines whether the current location of the human is within a first predetermined region 210. In some examples, the first predetermined region 210 is preset to be a region that surrounds the human-presence-responding luminance system 100's current location. If the human is currently located within the first predetermined region 210, go to Step 13. Else, if the human is not currently within the first predetermined region 210, go to Step 16.

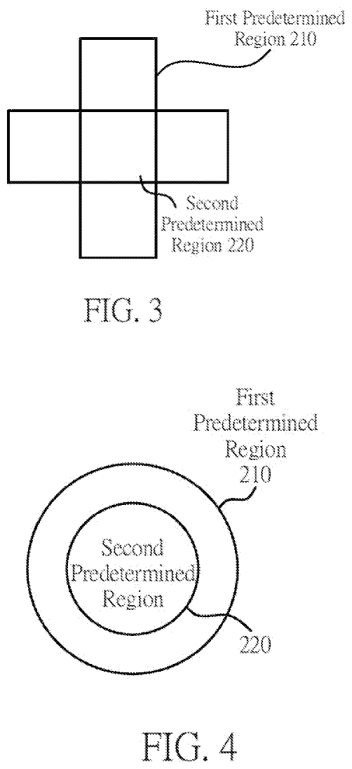

In Step 13, the luminance determining module 42 determines whether the current location of the human is within a second predetermined region 220. The first predetermined region 210 substantially covers the second predetermined region 220. In some examples, the second predetermined region 220 stands for a region that a human close the human-presence-responding luminance system 100 the most. FIG. 3 and FIG. 4 illustrate two examples illustrating the correspondence between the first predetermined region 210 and the second predetermined region 220. As shown in FIG. 3, the second predetermined region 220 separates all connected subregions of the first predetermined region 210. For example, the second predetermined region 220 may be a rectangle. As shown in FIG. 4, the first predetermined region 210 and the second predetermined region 220 are concentric circles having a same center. If the human is currently located within the second predetermined region 220, go to Step 14. Else, if the human is not currently within the second predetermined region 220, go to Step 15.

In Step 14, since the human is currently located within the second predetermined region 220, the luminance adjusting module 42 sets a luminance controlling signal to a first average luminance. The first average luminance indicates a highly concentrated luminance that a closing human may need. For example, the first average luminance may apply a higher luminance illuminated from the illuminating device 110, a brighter color temperature (e.g. a warm color temperature) radiated by the illuminating device 110, and/or a higher flashing frequency of the illuminating device 110.

In Step 15, when the human is currently located within the first predetermined region 210 but not within the second predetermined region 220, the luminance adjusting module 42 sets the luminance controlling signal to a second average luminance. The second average luminance indicates a less concentrated luminance (may be slightly) than the first average luminance. For example, the second average luminance may apply a less-higher luminance illuminated from the illuminating device 110, a darker color temperature (e.g. a cold color temperature) radiated by the illuminating device 110, and/or a less high flashing frequency of the illuminating device 110.

In Step 16, since the human's current location is not within the first predetermined location 210, the luminance adjusting module 42 sets a close signal, such that the illuminating device 110 may close immediately or gradually because the human may not need lights from the human-presence-responding luminance system 100 currently.

Last, the transmission module 43 forwards the luminance adjusting module 42's luminance decision signal to the illuminating device 110. In this way, the illuminating device 110 follows commands of the luminance decision signal to adjust its luminance correspondingly.

By adjusting the illuminating device 110's luminance in response to the detected human's proximity to the human-presence-responding luminance system 100, the human-presence-responding luminance system 100 is capable of avoiding unnecessary power consumption. If multiple such human-presence-responding luminance systems 100 are arranged and integrated, for example, as an array or matrix, the integration of the human-presence-responding luminance systems 100 may exploit advantages of different types (or resolutions) of utilized human proximity sensors. Such that the human-presence-responding luminance systems 100 can fulfill more flexible illumination functionality without wasting unnecessary power consumption. Such integration will be introduced later.

In one example, the luminance determining module 42 also takes a lasting time of the detected human as a factor of adjusting the illuminating device 110's luminance. More specifically, by determining a lasting time of the detected human who stays within the first predetermined region 210, the luminance determining module 42 may exclude the detected human's quick visit to the first predetermined region 210. Such that the human's quick visit will not falsely trigger a luminance increase of the illuminating device 110.

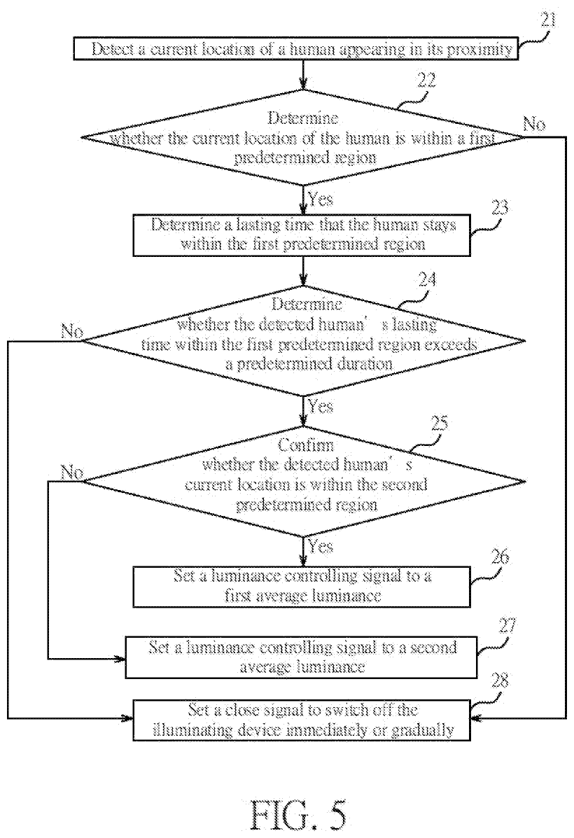

FIG. 5 illustrates a flowchart of how human-presence-responding luminance system 100 adjusts the illuminating device 110's luminance by additionally taking a lasting time of a detected human into considerations. Specifically, the luminance determining module 42 confirms whether the detected human's lasting time of staying within the first predetermined region 210 before confirming whether the detected human's current location is within the second predetermined region 220.

Step 21 resembles Step 11. Step 22 resembles Step 12. Step 26 resembles Step 14. And Step 27 resembles Step 15. Repeated descriptions of the resembling steps are skipped for brevity.

In Step 23, after the luminance determining module 42 confirms that the detected human's current location is located within the first predetermined region 210, the luminance determining module 42 determines a lasting time that the human stays within the first predetermined region 210.

In Step 24, the luminance determining module 42 determines whether the detected human's lasting time within the first predetermined region 210 exceeds a predetermined duration. In some examples, the predetermined duration indicates a minimal time interval that a human intends to stay within the first predetermined region 210 for personal activities. If the lasting time exceeds the predetermined duration, go to Step 25. Else, if the lasting time fails to exceed the predetermined duration, go to Step 28.

In Step 25, after the luminance determining module 42 confirms the detected human stays over the predetermined duration, the luminance determining module 42 confirms whether the detected human's current location is within the second predetermined region 220. If the detected human's current location is within the second predetermined region 220, go to Step 26 for setting a higher average luminance, as instructed in Step 14. If the detected human's current location falls off the second predetermined region 220 (but still within the first predetermined region 210), go to Step 27 for setting a lower average luminance, as instructed in Step 15.

In Step 28, since the detected human fails to exceed the predetermined duration to stay within the first predetermined region 210, it is no longer necessary to switch on the illuminating device 110. In response, the luminance determining module 42 sets the luminance controlling signal to render the illuminating device 110 to switch off immediately or gradually. That is, set a close signal.

Steps shown in FIG. 5 leads the human-presence-responding luminance system 100 in better and efficient power consumption by avoiding unnecessary switching on the illuminating device 110 once the detected human intends not to stay within the first predetermined region 210 for the predetermined duration.

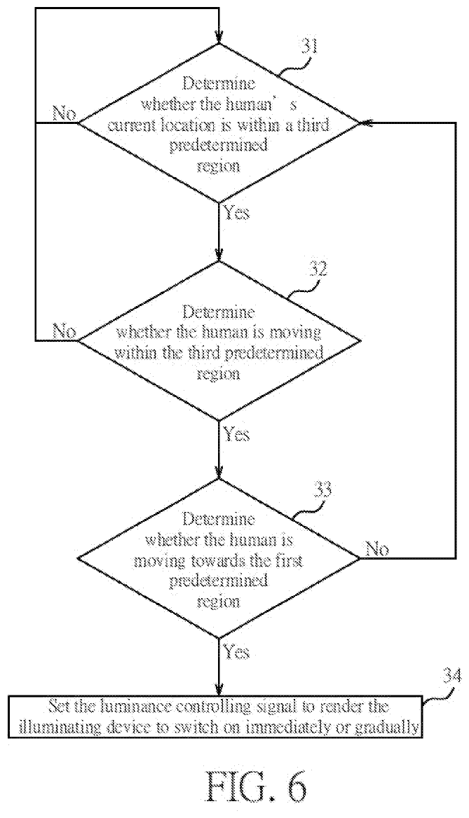

In some examples, before the detected human enters the first predetermined region 210, the luminance determining system 42 detects the human's moving direction in advance. Such that the human-presence-responding luminance system 100 can light up the detected human's way to the first predetermined region 210 before he/she reaches the first predetermined region 210. The detected human can have a better user experience of luminance. FIG. 6 illustrates how the luminance determining module 42 prepares lighting up the detected human's way before he/she reaches the first predetermined region 210 according to one example. The steps shown in FIG. 6 are performed after detecting the detected human's current location, i.e., after performing Step 11 or Step 21.

In Step 31, the luminance determining module 42 determines whether the human's current location is within a third predetermined region 230. The third predetermined region 230 substantially covers the first predetermined region 210. If the human's current location is within the third predetermined region 230, go to Step 32. Else, go back to Step 31 to continue detecting.

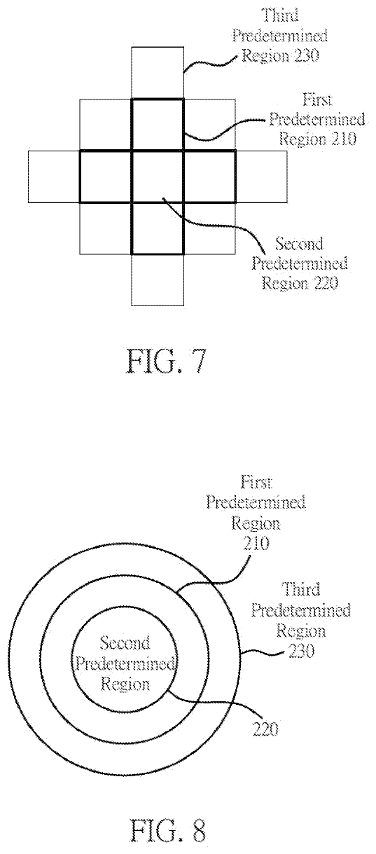

In some examples, the first predetermined region 210 substantially separates all connected subregions of the third predetermined region 230, as shown in FIG. 7. Also, in some examples, the first predetermined region 210, the second predetermined region 220 and the third predetermined region 230 are concentric circles having a same center, as shown in FIG. 8.

In Step 32, the luminance determining module 42 determines whether the human is moving within the third predetermined region 230. Specifically, the luminance determining module 42 may detect the human's current location again. In this way, the luminance determining module 42 compares the re-detected location with the previous detected location (in Step 11 or Step 21) to confirm if the detected human is moving. If the human is moving, go to Step 33. Else, if the human stays, go back to Step 31 to continue detecting.

In Step 33, the luminance determining module 42 also determines whether the human is moving towards the first predetermined region 210. If the human is moving towards the first predetermined region 210, go to Step 34. Else, if the human is moving away from the first predetermined region 210, go back to Step 31 to keep on detecting.

In Step 34, since the human is closing the first predetermined region 210, the luminance determining module 42 may light the human's way in advance. Specifically, the luminance determining module 42 sets the luminance controlling signal to render the illuminating device 110 to switch on immediately or gradually. In this way, the human experiences a better vision while moving towards the human-presence-responding luminance system 100.

In some examples, the luminance determining module 42 is integrated with the human proximity sensor 41. Such that the human's current location can be transmitted to the luminance determining module 42 in a more efficient manner.

In some examples, the luminance determining module 42 is integrated with the illuminating device 110. Such that the illuminating device 110 is capable of responding to the luminance determining module 42's luminance control signal in a quicker manner.

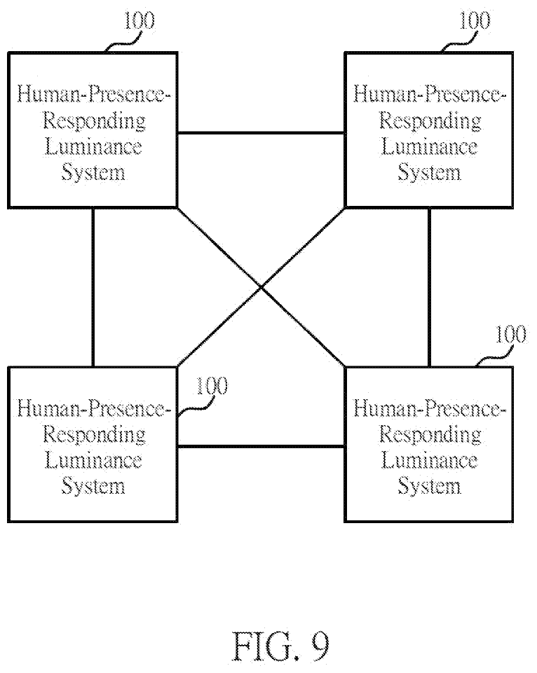

In some embodiments, the human-presence-responding systems 100 includes multiple illuminating devices 110 and multiple luminance adjusting devices 120. And each the multiple illuminating device 110 corresponds to a unique luminance adjusting device 120, i.e., in a one-by-one correspondence. Also, the multiple luminance adjusting devices 120 are arranged in a matrix, e.g., in a mesh. FIG. 9 illustrates an exemplary diagram of coupling multiple luminance adjusting devices 120 in a mesh.

Coupling the luminance adjusting devices 120 introduces several benefits. First, each human proximity sensor of the coupled luminance adjusting devices 120 can be completely or at least partially connected to each other, for example, directly or wirelessly. In this way, the detected human's location can be efficiently and more responsively forwarded to other luminance adjusting devices 120, e.g., in the same matrix, with the aid of respective transmission module 130. In some examples, a human proximity sensor 41 that detects a human's current location can forward the human's detected current location to a selected plurality of other luminance adjusting devices 120 in the same matrix. In some other examples, a human proximity sensor 41 that detects a human's current location may forward the human's detected current location to all of other luminance adjusting devices 120 in the same matrix.

Second, by coupling more luminance adjusting devices 120 in a same matrix, a detection range of the matrix can be efficiently increased. Such that the matrix can be more response to any movement of the detected human to illuminate. For example, the coupled luminance adjusting devices 120 can be more uniformly distributed within an indoor space, such that precision of detecting a human's location and movement can be raised.

In some examples, the luminance determining module 42 is implemented using at least a processor and a storage device. The steps shown in FIG. 2, FIG. 5 and FIG. 6 can be stored in the storage device and executed by the processor. The processor is capable of performing the steps in integral or separately, according to a built-in and/or updatable procedure installed within the processor.

In some examples, the human-presence-responding luminance system 100 can be implemented in a personal computer, a laptop, a palm digital assistant (PDA), or a cloud server.

In some examples, the processor can be implemented using a central processing unit (CPU), a digital signal processor (DSP), an application specific integrated circuit (ASIC), a field-programmable gate array (FPGA), or other appropriate hardware.

The storage device can be implemented using a hard drive or a built-in storage device of the human-presence-responding luminance system 100. The storage device may also be an external storage unit. Such as a plug-in hard drive, a smart media card (SMC), a secure digital (SD) card, a flash card, or a memory device utilizing read-only memory (ROM), a random access memory (RAM) or both.

Those skilled in the art will readily observe that numerous modifications and alterations of the device and method may be made while retaining the teachings of the invention. Accordingly, the above disclosure should be construed as limited only by the metes and bounds of the appended claims.

1. A human-presence-responding luminance system, comprising:
an illuminating device; and
a luminance adjusting device, electronically coupled to the illuminating device, wherein the luminance adjusting module comprises:
a proximity sensor, configured to detect a current location of a human appearing in its proximity;
a luminance determining module, configured to determine whether the current location of the human is within a first predetermined region, configured to determine whether the current location of the human is within a second predetermined region substantially covered by the first predetermined region when the human is located within the first predetermined region, configured to set a luminance controlling signal to a first average luminance when the current location of the human is within the second predetermined region, and configured to set the luminance controlling signal to a second average luminance when the current location of the human is within the first predetermined region but is not within the second predetermined region; and
a transmission module, configured to relay the luminance controlling signal to the illuminating device;
wherein the first average luminance is higher than the second average luminance;
wherein the illuminating device is configured to illuminate according to an average luminance indicated by the luminance controlling signal, wherein factors of the average luminance comprise a color temperature radiated from the illuminating device.

2. The human-presence-responding luminance system of claim 1, wherein factors of the average luminance comprise a magnitude of luminance radiated from the illuminating device, and/or a flashing frequency of the illuminating device.

3. The human-presence-responding luminance system of claim 1, wherein the second predetermined region separates all connected subregions of the first predetermined region.

4. The human-presence-responding luminance system of claim 1, wherein the first predetermined region and the second predetermined region are concentric circles having a same center.

5. The human-presence-responding luminance system of claim 1, wherein when the luminance determining module determines that the current location of human falls outside the first predetermined region, the luminance determining module is further configured to set the luminance controlling signal to render the illuminating device to switch off immediately or gradually.

6. The human-presence-responding luminance system of claim 1, wherein the luminance determining module is further configured to determine a lasting time that the human stays within the first predetermined region, and further configured to determine whether the lasting time exceeds a predetermined duration.

7. The human-presence-responding luminance system of claim 6, wherein the luminance determining module is further configured to set the luminance controlling signal to render the illuminating device to switch off immediately or gradually when the lasting time fails to exceed the predetermined duration.

8. The human-presence-responding luminance system of claim 1, wherein the luminance determining module is further configured to determine whether the current location of the human is within a third predetermined region that substantially covers the first predetermined region, further configured to determine whether the human is moving within the third predetermined region upon determining that the human is within the third predetermined region, further configured to determine whether the human is moving towards the first predetermined region upon determining that the human is moving, and further configured to set the luminance controlling signal to render the illuminating device to switch on immediately or gradually when the human is moving towards the first predetermined region.

9. The human-presence-responding luminance system of claim 8, wherein the first predetermined region separates all connected subregions of the third predetermined region.

10. The human-presence-responding luminance system of claim 8, wherein the first predetermined region, the second predetermined region and the third predetermined regions are concentric circles having a same center.

11. The human-presence-responding luminance system of claim 1, wherein the luminance determining module is integrated with the proximity sensor.

12. The human-presence-responding luminance system of claim 1, wherein the luminance determining module is integrated with the illuminating device.

13. A human-presence-responding luminance system, comprising:
a plurality of illuminating devices; and
a plurality of luminance adjusting devices having a one-by-one correspondence with the plurality of illuminating devices;
wherein the plurality of luminance adjusting devices are arranged in a matrix, and each of the plurality of luminance adjusting device comprises:
a proximity sensor, configured to detect a current location of a human appearing in its proximity;
a luminance determining module, configured to determine whether the current location of the human is within a first predetermined region, configured to determine whether the current location of the human is within a second predetermined region substantially covered by the first predetermined region when the human is located within the first predetermined region, configured to set a luminance controlling signal to a first average luminance when the current location of the human is within the second predetermined region, and configured to set the luminance controlling signal to a second average luminance when the current location of the human is within the first predetermined region but is not within the second predetermined region; and
a transmission module, configured to relay the luminance controlling signal to a correspond illuminating device out of the plurality of illuminating devices;
wherein the first average luminance is higher than the second average luminance;
wherein the corresponding illuminating device is configured to illuminate according to an average luminance indicated by the luminance controlling signal;
wherein the proximity sensors of all the plurality of luminance adjusting devices are further configured to communicate with each other with the aid of the transmission module, wherein factors of the average luminance comprises a color temperature radiated from the illuminating device.

14. The human-presence-responding luminance system of claim 13, wherein factors of the average luminance comprise a magnitude of luminance radiated from the illuminating device, and/or a flashing frequency of the illuminating device.

15. The human-presence-responding luminance system of claim 13, wherein the second predetermined region separates all connected subregions of the first predetermined region.

16. The human-presence-responding luminance system of claim 13, wherein the first predetermined region and the second predetermined region are concentric circles having a same center.

17. The human-presence-responding luminance system of claim 13, wherein when the luminance determining module determines that the current location of human falls outside the first predetermined region, the luminance determining module is further configured to set the luminance controlling signal to render the corresponding illuminating device to switch off immediately or gradually.

18. The human-presence-responding luminance system of claim 13, wherein the luminance determining module is further configured to determine a lasting time that the human stays within the first predetermined region, and further configured to determine whether the lasting time exceeds a predetermined duration.

19. The human-presence-responding luminance system of claim 18, wherein the luminance determining module is further configured to set the luminance controlling signal to render the corresponding illuminating device to switch off immediately or gradually when the lasting time fails to exceed the predetermined duration.

20. The human-presence-responding luminance system of claim 13, wherein the luminance determining module is further configured to determine whether the current location of the human is within a third predetermined region that substantially covers the first predetermined region, further configured to determine whether the human is moving within the third predetermined region upon determining that the human is within the third predetermined region, further configured to determine whether the human is moving towards the first predetermined region upon determining that the human is moving, and further configured to set the luminance controlling signal to render the corresponding illuminating device to switch on immediately or gradually when the human is moving towards the first predetermined region.

21. The human-presence-responding luminance system of claim 20, wherein the first predetermined region separates all connected subregions of the third predetermined region.

22. The human-presence-responding luminance system of claim 20, wherein the first predetermined region, the second predetermined region and the third predetermined regions are concentric circles having a same center.

23. The human-presence-responding luminance system of claim 13, wherein the luminance determining module is integrated with the proximity sensor.

24. The human-presence-responding luminance system of claim 13, wherein the luminance determining module is integrated with the corresponding illuminating device.

25. The human-presence-responding luminance system of claim 13, wherein the proximity sensor is further configured to forward the current location of the human to at least one the other luminance adjusting device with the aid of the transmission module.

26. The human-presence-responding luminance system of claim 25, wherein the proximity sensor is further configured to select the at least one the other luminance adjusting device for forwarding the current location of the human according to proximities of the current location of the human to the other luminance adjusting devices.
